(19) United States
(12) Patent Application Publication
(10) Pub. No.: US 2007/0122559 A1
(43) Pub. Date: May 31, 2007

(54) Processing liquid coating apparatus and a processing liquid coating method

(76) Inventors: Mitsuhiko Shirakashi, Toyko (JP); Masayoshi Hirose, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/573,915

(22) PCT Filed: Oct. 27, 2004
(86) PCT No.: PCT/JP04/16284

§ 371 Date: Mar. 30, 2006

(30) Foreign Application Priority Data
Oct. 31, 2003 (JP) 2003-373392

(51) Int. Cl. G21H 5/00; H01F 41/00; G21H 1/00; B01J 19/08

(52) U.S. Cl. 427/457

(57) ABSTRACT

The present invention relates to a processing liquid coating apparatus and a processing liquid coating method suitable for use in a lithography process for forming fine circuit patterns on a surface of a substrate such as a semiconductor wafer. The processing liquid coating apparatus according to the present invention includes a substrate holder (1) for holing and rotating a substrate (W), and a processing liquid supply unit (2) disposed apart from the substrate (w) held by the substrate holder (1). The processing liquid supply unit (2) has a plurality of supply ports (5, 6) for supplying a processing liquid to a plurality of portions including a central portion (C) of a surface of the substrate (W). A resist liquid or a developer is used as the processing liquid.

### TECHNICAL FIELD

The present invention relates to a processing liquid coating apparatus and a processing liquid coating method, and more particularly to a processing liquid coating apparatus and a processing liquid coating method suitable for use in a lithography process for forming fine circuit patterns in a surface of a substrate such as a semiconductor wafer.

### BACKGROUND ART

In a semiconductor fabrication apparatus, a lithography process is conducted for forming fine circuit patterns in a surface of a substrate such as a semiconductor wafer. This lithography process involves a combination of a resist coating process for forming a resist film on a surface of a wafer, a pattern exposure process for transferring circuit patterns to the resist film, and a development process for forming circuit pattern grooves in the resist film along the transferred circuit patterns. Hereinafter, there will be described the resist coating process, the pattern exposure process, and the development process in detail.

(1) Resist Coating Process

Generally, the resist coating process is performed using resist coating equipment which is called a spin coater. In this resist coating process, a wafer having an insulating film on a surface thereof is held by a spin chuck, and is then rotated by the spin chuck. In this state, a resist liquid is supplied from a nozzle disposed above a central portion of the spin chuck onto a central portion of the surface of the wafer, so that the resist liquid spreads over the entire surface of the wafer due to a centrifugal force. Thereafter, the supply of the resist liquid is stopped and then the rotational speed of the wafer is lowered. In this manner, a thin resist film (i.e., a photosensitive polymer film) is formed on the entire surface of the wafer. The resist is classified into two types, a positive type in which exposed portions are removed by the development process, and a negative type in which non-exposed portions are removed by the development process.

(2) Pattern Exposure Process

Generally, the pattern exposure process is performed using exposure equipment which is called a stepper. In this pattern exposure process, the wafer having the resist film on the surface thereof is placed on a stage. A light source such as an i line or an excimer laser is disposed above the stage, and a mask (a reticle) having circuit patterns formed thereon is disposed between the stage and the light source. A light from the light source passes through the mask and is applied to the resist film on the wafer, thus transferring the circuit patterns to the resist film. In this exposure process, it is required to sharply transfer the circuit patterns with a desired dimension to the entire resist film.

(3) Development Process

Generally, the development process is performed using developing equipment. In this development process, a developer (i.e., a developing solution) is supplied onto the central portion of the resist film on the wafer while the wafer is held and rotated by a substrate holder, so that the developer spreads over the entire resist film due to a centrifugal force. In a case of using the positive-type resist, the developer reacts with the exposed portions of the resist film where the circuit patterns have been transferred, and the exposed portions are dissolved in the developer. On the other hand, in a case of using the negative-type resist, the developer reacts with the non-exposed portions of the resist film where the circuit patterns have not been transferred, and the non-exposed portions are dissolved in the developer. As the wafer is rotated, the developer that has been supplied to the resist film is replaced with a new developer, whereby the chemical reaction proceeds further. In this manner, the circuit pattern grooves are formed in the resist film. Thereafter, a rinsing liquid is supplied onto the wafer to stop the development reaction, and then the wafer is rotated at a high speed to be spin-dried.

In this lithography process, in order to achieve a high resolution of the circuit patterns to be transferred to the resist film, it is required to uniformly coat the entire surface of the wafer with the resist film having a desired thickness. Further, in order to reduce a fabrication cost, it is required to reduce amounts of the resist liquid and the developer to be supplied as small as possible.

However, since the above-mentioned resist coating process utilizes the centrifugal force so as to spread the resist liquid, a large amount of the resist liquid is required to be supplied to the wafer while the excess resist liquid is thrown off the wafer. Therefore, a much larger amount of the resist liquid is used than is required to form the resist film, thus causing an increased fabrication cost.

In addition, due to a balance between the centrifugal force and the surface tension, the resist film tends to be formed in such a state that a peripheral portion thereof is thicker than a central portion. Accordingly, a resist film having a uniform thickness cannot be formed, and hence the resolution of the circuit patterns is lowered in the subsequent exposure process.

Further, in the development process, since the developer is supplied onto the central portion of the resist film (wafer) as with the resist coating process, there is a difference in contact time with the developer between the central portion and the peripheral portion of the resist film, and hence the uniform development cannot be performed. In addition, although the developer on the wafer is replaced with a new developer by the rotation of the wafer in the above-mentioned development process, the replacement of the developer in the circuit pattern grooves is not performed sufficiently. Specifically, an upper layer of the developer flows smoothly as a laminar flow. In contrast thereto, the developer near the surface of the resist film flows as a viscous flow. Accordingly, the replacement of the developer is not performed smoothly in the circuit pattern grooves, resulting in a non-uniform development and a long development time. In the rinsing process after the development process, since the replacement of the rinsing liquid is not performed smoothly because of the same reason as described above, the development cannot be stopped as intended, resulting in an excessive development.

Furthermore, in the drying process after the rinsing process, the high-speed rotation of the wafer may cause wall portions constituting the circuit patterns to collapse, which is a so-called pattern collapse. If the rotational speed is decreased in order to prevent the pattern collapse, the rinsing liquid are likely to remain in the circuit pattern grooves, and hence the wafer cannot be dried sufficiently. Such pattern collapse is expected to occur more remarkably as the circuit pattern becomes smaller in size.

### DISCLOSURE OF INVENTION

The present invention has been made in view of the above drawbacks. It is therefore an object of the present invention to provide a processing liquid coating apparatus and a processing liquid coating method which can uniformly coat a surface of a substrate with a small amount of a processing liquid such as a resist liquid or a developer and can perform a replacement of the processing liquid smoothly, and can also prevent a pattern collapse.

In order to achieve the above object, according to one aspect of the present invention, there is provided a processing liquid coating apparatus for coating a surface of a substrate with a processing liquid, the apparatus comprising: a substrate holder for holing and rotating the substrate; and a processing liquid supply unit disposed apart from the substrate held by the substrate holder; wherein the processing liquid supply unit has a plurality of supply ports for supplying the processing liquid to a plurality of portions including a central portion of the surface of the substrate, and the processing liquid is a resist liquid or a developer.

In a preferred aspect of the present invention, the processing liquid supply unit has a plurality of suction ports for sucking the processing liquid on the substrate.

In a preferred aspect of the present invention, the plurality of supply ports and the plurality of suction ports are arranged alternately and linearly.

In a preferred aspect of the present invention, the processing liquid supply unit is movable in a radial direction of the substrate.

In a preferred aspect of the present invention, the processing liquid coating apparatus further comprises a processing liquid suction unit for sucking the processing liquid from a peripheral portion of the substrate.

In a preferred aspect of the present invention, the processing liquid coating apparatus further comprises a gas supply unit for ejecting a gas toward the surface of the substrate, the gas supply unit being movable from the central portion to a peripheral portion of the substrate.

According to another aspect of the present invention, there is provided a processing liquid coating method for coating a surface of a substrate with a processing liquid, the method comprising: rotating the substrate; and supplying the processing liquid to a plurality of portions including a central portion of the surface of the substrate; wherein the processing liquid is a resist liquid or a developer.

In a preferred aspect of the present invention, the processing liquid coating method further comprises sucking the processing liquid from a plurality of portions of the surface of the substrate.

In a preferred aspect of the present invention, the processing liquid coating method further comprises sucking the processing liquid from a plurality of portions including a peripheral portion of the surface of the substrate.

In a preferred aspect of the present invention, the processing liquid coating method further comprises ejecting a gas from a gas supply unit toward the surface of the substrate; and moving the gas supply unit from the central portion to a peripheral portion of the substrate.

According to the present invention, all portions of the surface of the substrate can be supplied with the processing liquid (i.e., the resist liquid or the developer) at substantially the same time. Therefore, a film (e.g.,a resist film) of the processing liquid can be uniformly formed on the surface of the substrate even if a small amount of the processing liquid is used. Further, because the processing liquid can be supplied over the entire surface of the substrate without utilizing the centrifugal force, the substrate is allowed to rotate at a low rotational speed. Therefore, it is possible to reduce an amount of the processing liquid scattered from the substrate while the substrate is being rotated. Furthermore, by sucking the processing liquid on the substrate and supplying the dry gas to the substrate, the substrate can be dried sufficiently even if the substrate is rotated at a low rotational speed. Therefore, it is possible to prevent the pattern collapse.

### BRIEF DESCRIPTION OF DRAWINGS

FIG. 1A is a plan view showing a processing liquid coating apparatus according to a first embodiment of the present invention;

FIG. 1B is a side view of the processing liquid coating apparatus shown in FIG. 1A;

FIG. 2A is an enlarged view showing a processing liquid supply unit shown in FIG. 1B;

FIG. 2B is a cross-sectional view taken along line IIb-IIb of FIG. 2A;

FIG. 2C is a cross-sectional view taken along line IIc-IIc of FIG. 2A;

FIG. 3 is a schematic view showing a reuse system;

FIG. 4A is a plan view showing another example of a substrate holder;

FIG. 4B is a cross-sectional view of the substrate holder shown in FIG. 4A;

FIG. 4C is a cross-sectional view showing a modification example of the substrate holder shown in FIG. 4B;

FIG. 5A is an enlarged view showing a processing liquid supply unit incorporated in a processing liquid coating apparatus according to a second embodiment of the present invention;

FIG. 5B is a cross-sectional view taken along line Vb-Vb of FIG. 5A; and

FIG. 5C is a cross-sectional view taken along line Vc-Vc of FIG. 5A.

### BEST MODE FOR CARRYING OUT THE INVENTION

A processing liquid coating apparatus according to embodiments of the present invention will be described below with reference to the drawings.

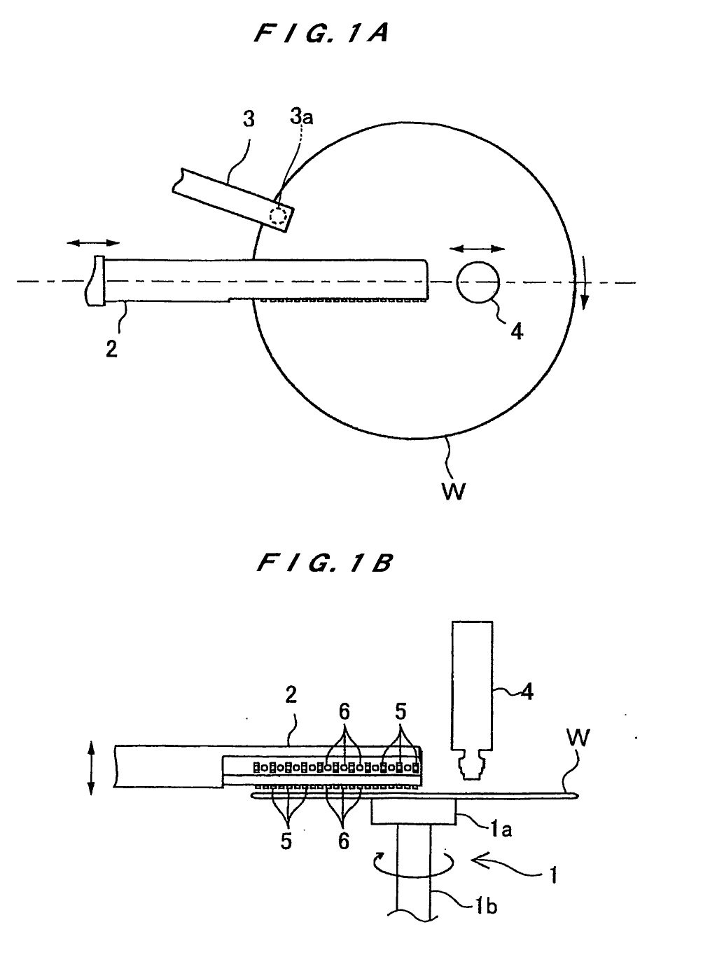

FIG. 1A is a plan view showing a processing liquid coating apparatus according to a first embodiment of the present invention, and FIG. 1B is a side view of the processing liquid coating apparatus shown in FIG. 1A.

As shown in FIGS. 1A and 1B, the processing liquid coating apparatus comprises a substrate holder 1 for holding and rotating a wafer (i.e., a substrate) W horizontally, a processing liquid supply unit 2 for supplying a predetermined processing liquid onto an upper surface of the wafer W held by the substrate holder 1, a processing liquid suction unit 3 for sucking the processing liquid from a peripheral portion of the wafer W, and a gas supply unit 4 for supplying a predetermined gas to the upper surface of the wafer W.

The substrate holder 1 comprises a rotating shaft 1a, and a circular chuck table 1b fixed to an upper end of the rotating shaft la. A through hole (not shown) is formed in the rotating shaft 1a and the chuck table 1b so that the wafer W is attracted to an upper surface of the chuck table 1b by producing a negative pressure in the through hole. The rotating shaft 1a is coupled to a drive source (not shown) such as a motor, and the wafer W on the chuck table 1b is rotated by the drive source together with the rotating shaft 1a.

The processing liquid supply unit 2 is disposed apart from the wafer W held by the substrate holder 1. In FIG. 1B, the processing liquid supply unit 2 is positioned above the wafer W. The processing liquid supply unit 2 has a substantially column shape and extends along a radial direction of the wafer W. Each of a lower portion and a side portion of the processing liquid supply unit 2 has a plurality of first supply ports 5 and a plurality of second supply ports 6 for supplying the processing liquid onto the surface of the wafer W.

The processing liquid suction unit 3 is disposed adjacent to the processing liquid supply unit 2 and positioned at the forward of the processing liquid supply unit 2 in a rotational direction of the wafer W. This processing liquid suction unit 3 has an open mouth 3a positioned above the peripheral portion of the wafer W so that the processing liquid that has been supplied to the upper surface of the wafer W is suck through the open mouth 3a of the processing liquid suction unit 3.

Although only one processing liquid suction unit 3 is provided in this embodiment, a plurality of processing liquid suction units may be provided along the peripheral portion of the wafer W. Further, the processing liquid suction unit 3 may be disposed below the wafer W instead of above the wafer W. Furthermore, in a case where a rotational axis of the wafer W is in a horizontal orientation, the processing liquid suction unit 3 may be disposed laterally of the wafer W.

The gas supply unit 4 is disposed above the wafer W (i.e., the substrate holder 1) so that a dry gas is ejected from a lower portion of the gas supply unit 4 toward the upper surface of the wafer W. The dry gas may preferably comprise an inert gas such as an N₂ gas or a dry air having a humidity of not more than 10%. The gas supply unit 4 is movable from the central portion to the peripheral portion of the wafer W.

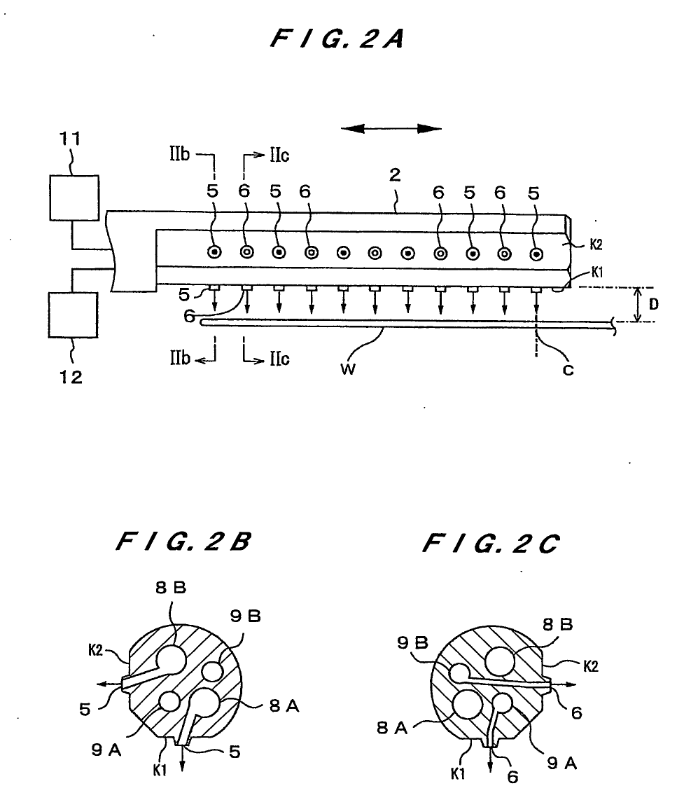

An example of a structure of the above-mentioned processing liquid supply unit will be described below with reference to FIGS. 2A through 2C. FIG. 2A is an enlarged view showing the processing liquid supply unit shown in FIG. 1B, FIG. 2B is a cross-sectional view taken along line IIb-IIb of FIG. 2A, and FIG. 2C is a cross-sectional view taken along line IIc-IIc of FIG. 2A.

The processing liquid supply unit 2 has an operation surface (a first operation section) K1 and an operation surface (a second operation section) K2 located respectively on the lower portion and the side portion thereof. Each of the operation surfaces K1 and K2 has the plurality of first supply ports 5 and the plurality of second supply ports 6. The first supply ports 5 and the second supply ports 6 are arranged linearly along a longitudinal direction of the processing liquid supply unit 2, i.e., the radial direction of the wafer W. The first supply ports 5 and the second supply ports 6 are disposed alternately with a predetermined distance therebetween, and one of the first supply ports 5 is positioned above the central portion C of the wafer W. In this embodiment, as shown in FIG. 2A, a first supply port 5 disposed at a tip end of the processing liquid supply unit 2 is positioned above the central portion C of the wafer W.

The processing liquid supply unit 2 is rotatable about its longitudinally extending axis by an angle of 90°, so that either the operation surface K1 or the operation surface K2 faces the upper surface of the wafer W. The number of first supply ports 5 and the number of second supply ports 6 on the operation surfaces K1 and K2 are determined according to a diameter of the wafer W. The processing liquid supply unit 2 is operable to independently adjust flow rates of the processing liquid supplied from the respective first supply ports 5 and the respective second supply ports 6. Valves may be used as means for adjusting the flow rates of the processing liquid. As a distance (referred to as radius “r”) from the central portion C of the wafer W becomes long, a circumference, which is given by formula 2πr, also becomes long. Therefore, the flow rates of the processing liquid supplied from the respective first supply ports 5 and the respective second supply ports 6 are adjusted so as to increase gradually from the central portion to the peripheral portion of the wafer W.

As shown in FIGS. 2B and 2C, a pair of first communication passages 8A and 8B and a pair of second communication passages 9A and 9B are provided in the processing liquid supply unit 2 and extend in the longitudinal direction of the processing liquid supply unit 2. As shown in FIG. 2B, the first supply ports 5, which open at the first operation surface K1, communicate with the first communication passage 8A, and the first supply ports 5, which open at the second operation surface K2, communicate with the first communication passage 8B. As shown in FIG. 2C, the second supply ports 6, which open at the first operation surface K1, communicate with the second communication passage 9A, and the second supply ports 6, which open at the second operation surface K2, communicate with the second communication passage 9B.

The first communication passage 8A and the second communication passage 9A are connected to a first processing liquid supply source 11 shown in FIG. 2A. With this structure, by supplying a processing liquid (a first processing liquid) from the first processing liquid supply source 11 to the first communication passage 8A and the second communication passage 9A, the processing liquid is supplied onto the wafer W through the first supply ports 5 and the second supply ports 6 disposed on the operation surface K1. On the other hand, the first communication passage 8B and the second communication passage 9B are connected to a second processing liquid supply source 12. With this structure, by supplying a processing liquid (a second processing liquid) from the second processing liquid supply source 12 to the first communication passage 8B and the second communication passage 9B, the processing liquid is supplied onto the wafer W through the first supply ports 5 and the second supply ports 6 disposed on the operation surface K2. The first processing liquid supply source 11 and the second processing liquid supply source 12 are designed so as to independently control a flow rate, a pressure, a temperature, pH, and a viscosity of the processing liquid.

The first processing liquid and the second processing liquid supplied respectively from the first and second processing liquid supply sources 11 and 12 may be of the same type or different types. For example, both of the first and second processing liquid supply sources 11 and 12 may supply a resist liquid through the first supply ports 5 and the second supply ports 6. Alternatively, the first processing liquid supply source 11 may supply a developer through the first and second supply ports 5 and 6 on the operation surface K1, and then the second processing liquid supply source 12 may supply a rinsing liquid through the first and second supply ports 5 and 6 on the operation surface K2. A third processing liquid supply source (not shown) and a fourth processing liquid supply source (not shown) may be further provided so that the first communication passages 8A and 8B and the second communication passages 9A and 9B are connected to the first, second, third, and fourth processing liquid supply sources, respectively. With this structure, by switching the operation surfaces K1 and K2 therebetween, four types of processing liquids can be supplied onto the wafer W.

When switching the operation surfaces K1 and K2 and when switching the processing liquids, it is preferable to remove the processing liquid, which is used in the previous process, from the first and second supply ports 5 and 6 by ejecting a gas (e.g., a dry air or an inert gas) or pure water and then supply the next processing liquid. Further, suck back valves may be provided respectively in non-illustrated pipes (passages) connected respectively to the first communication passages 8A and 8B and the second communication passages 9A and 9B for sucking the processing liquid remaining on the first and second supply ports 5 and 6. The suck back valves serve to temporarily store a certain amount (e.g., ranging from 0.1 to 0.2 ml) of the liquid by producing a negative pressure therein when a certain signal is input thereto.

As shown in FIG. 2A, the processing liquid supply unit 2 is disposed near the surface (i.e., the upper surface) of the wafer w. This processing liquid supply unit 2 is supported by a holding mechanism (not shown) which is movable upwardly and downwardly, so that a distance D between the upper surface of the wafer W and the processing liquid supply unit 2 (i.e., tip ends of the first supply ports 5 and the second supply ports 6) can be adjusted. The distance D between the upper surface of the wafer W and the processing liquid supply unit 2 is preferably not more than 2 mm, more preferably not more than 0.5 mm. The above-mentioned holding mechanism is also movable horizontally, so that the processing liquid supply unit 2 is moved in the radial direction of the wafer W (i.e., the longitudinal direction of the processing liquid supply unit 2) by the holding mechanism as indicated by arrows of FIGS. 1A and 2A.

Next, operation of the processing liquid coating apparatus having the above structure will be described.

Firstly, the wafer W to be processed is transferred to the processing liquid coating apparatus, and is held by the substrate holder 1. Thereafter, the processing liquid supply unit 2 is moved to a position above the wafer W which is held by the substrate holder 1. Then, the wafer W is rotated at a predetermined rotational speed, and a processing liquid such as a resist liquid, a developer, or a rinsing liquid is supplied from the first and second supply ports 5 and 6 to the upper surface of the wafer W. The processing liquid is supplied onto a plurality of radially aligned portions including the central portion C of the wafer W, whereby the upper surface of the wafer W is coated with the processing liquid. At this time, the processing liquid, which has been moved to the peripheral portion of the wafer W due to a centrifugal force, is sucked through the open mouth 3a of the processing liquid suction unit 3. While the processing liquid is being supplied onto the upper surface of the wafer W, the wafer W is rotated at a rotational speed of not more than 1000 min⁻¹, preferably not more than 500 min⁻¹, more preferably not more than 100 min⁻¹, furthermore preferably not more than 50 min⁻¹. The processing liquid supply unit 2 may be reciprocated in the radial direction of the wafer W while supplying the processing liquid, as needed.

In a case where the processing liquid coating apparatus is used as developing equipment, the wafer W is processed in the following manner: A developer retained in the first processing liquid supply source 11 is supplied from the first supply ports 5 and the second supply ports 6, which are provided on the operation surface K1, onto the wafer W to perform a development process while the wafer W is being rotated at a rotational speed ranging from 10 to 300 min⁻¹. Thereafter, a rinsing liquid retained in the second processing liquid supply source 12 is supplied from the first supply ports 5 and the second supply ports 6, which are provided on the operation surface K2, onto the wafer W to stop the development and clean the wafer W. In order to increase the cleaning effect, an ultrasonic apply device (e.g., an ultrasonic transducer) may be provided so as to apply an ultrasonic wave to the rinsing liquid on the wafer W.

After the wafer W is cleaned, the dry gas is ejected from the gas supply unit 4 to the upper surface of the wafer W. The gas supply unit 4 is moved from the central portion to the peripheral portion of the wafer W while supplying the dry gas, whereby the rinsing liquid remaining on the upper surface of the wafer W is moved from the central portion to the peripheral portion of the wafer W and is then removed from the wafer W. In order to prevent the pattern collapse, the rotational speed of the wafer W during the drying process is set to be not more than 1000 min⁻¹, preferably not more than 500 min⁻¹, more preferably not more than 100 min⁻¹, furthermore preferably not more than 50 min⁻¹.

In a case where the processing liquid coating apparatus is used as resist coating equipment, a resist liquid is supplied from the first supply ports 5 and the second supply ports 6 onto the wafer W while the wafer W is being rotated at a rotational speed ranging from 10 to 300 min⁻¹.

According to the processing liquid coating apparatus of this embodiment, all portions of the upper surface of the wafer W can be supplied with the processing liquid (i.e., the resist liquid, the developer, or the rinsing liquid) at substantially the same time. Therefore, the processing liquid can cover the entire upper surface of the wafer W uniformly and quickly even when a small amount of the processing liquid is used. Specifically, in a case of using the resist liquid as the processing liquid, a total amount of the resist liquid to be supplied ranges from 10 to 200 ml, and in a case of using the developer as the processing liquid, a total amount of the developer to be supplied ranges from 10 to 200 ml.

Further, because the wafer W can be rotated at a low rotational speed, it is possible to reduce an amount of the processing liquid scattered from the wafer W. Furthermore, because the processing liquid supplied to the wafer W is sucked through the processing liquid suction unit 3 without contacting with any of other components, the processing liquid which has been recovered through the processing liquid suction unit 3 can be introduced into the first processing liquid supply source 11 and/or the second processing liquid supply source 12 for reuse.

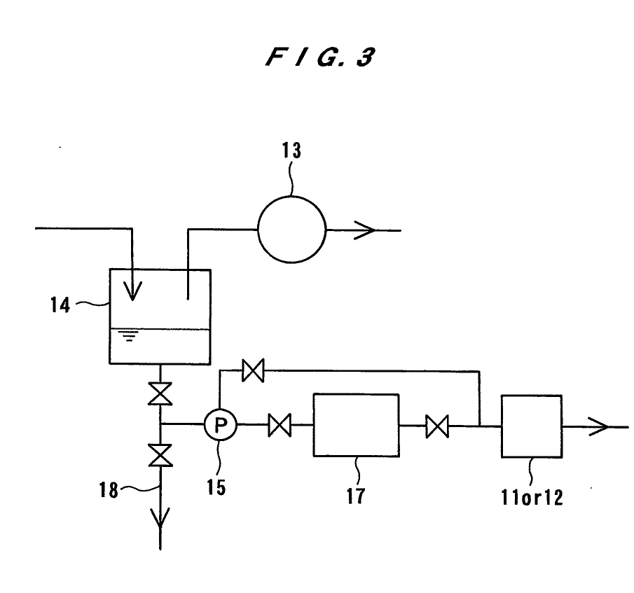

As shown in FIG. 3, the processing liquid which has been sucked through the processing liquid suction unit 3 is temporarily collected in the gas-liquid separator 14 where the processing liquid and a gas (e.g., air) are separated from each other. The processing liquid recovered by the gas-liquid separator 14 is returned to the first processing liquid supply source 11 and/or the second processing liquid supply source 12 again by a liquid-delivery pump 15, whereby the processing liquid can be reused. In a case where the recovered processing liquid is contaminated, this processing liquid cannot be reused as it is. In such a case, the processing liquid is introduced to a purification device 17 so that the purification device 17 purifies the processing liquid by removing impurities from the processing liquid. The purified processing liquid is then returned to the first processing liquid-supply source 11 and/or the second processing-liquid supply source 12 for reuse. In a case where the processing liquid is contaminated to such a degree that it cannot be reused even if the purification process is performed, the processing liquid recovered by the gas-liquid separator 14 is discharged through a discharge pipe 18.

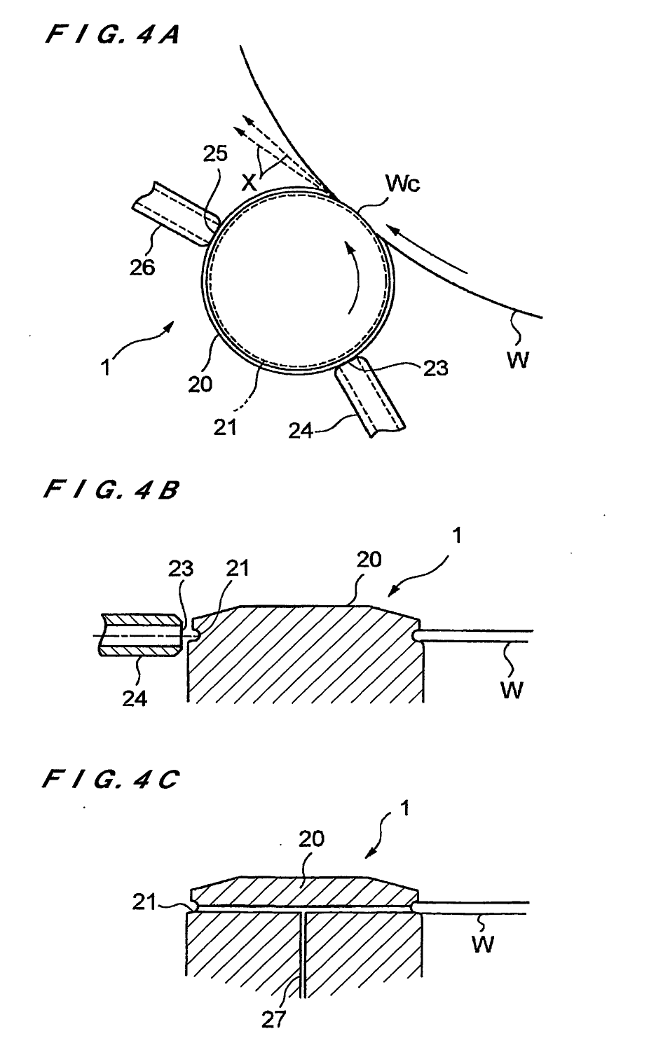

Although the substrate holder 1 shown in FIG. 1B is of a vacuum chuck type that holds the wafer W by the vacuum attraction, a substrate holder having a plurality of rollers for holding a substrate may be used instead of the vacuum-chuck-type substrate holder. Hereinafter, a substrate holder having a plurality of rollers will be described with reference to FIGS. 4A and 4B. FIG. 4A is a plan view showing another example of the substrate holder, and FIG. 4B is a cross-sectional view of the substrate holder shown in FIG. 4A.

The substrate holder 1 for holding a wafer W comprises a plurality of rollers 20 disposed along a circumferential direction of the wafer W (only one roller 20 is shown in FIGS. 4A and 4B). As shown in FIGS. 4A and 4B, each of the rollers 20 has a groove-like clamp portion 21 formed on its circumferential surface. The rollers 20 are moved toward the wafer W and thus brought into contact with an edge portion of the wafer W with a predetermined pressing force, whereby the wafer W is held by the clamp portions 21 of the rollers 20. In this state, all the rollers 20 are rotated at the same rotational speed in the same direction by a rotating mechanism, so that the wafer W is rotated horizontally by the rollers 20. In this case, at least one of the rollers 20 may be rotated by the rotating mechanism.

Suction nozzles 24 each having a suction mouth 23 are disposed near the clamp portions 21, respectively. The suction mouths 23 are positioned close to the clamp portions 21 with a distance of not more than 5 mm, for example, so as to suck a processing liquid that has adhered to the clamp portions 21. Similarly, cleaning nozzles 26 are disposed near the clamp portions 21 of the rollers 20, respectively, and each of the cleaning nozzles 26 has a supply mouth 25 for supplying a cleaning liquid to the clamp portions 21. The distance between the suction mouth 23 of the suction nozzle 24 and the clamp portion 21 is preferably not more than 1 mm, more preferably not more than 0.5 mm. In the same manner, the distance between the supply mouth 25 of the cleaning nozzle 26 and the clamp portion 21 is preferably not more than 1 mm, more preferably not more than 0.5 mm. The rollers 20 should preferably be made of fluororesin such as PVDF or PEEK, which has a chemical resistance, or polyurethane.

If the suction nozzle 24 is not provided, the processing liquid that has adhered to the clamp portion 21 is brought into contact with the wafer W again by the rotation of the roller 20, and the processing liquid is scattered in tangent directions X of the wafer W and the roller 20 (see FIG. 4A). In order to prevent such a scattering of the processing liquid, the suction mouth 23 and the supply mouth 25 are disposed in the following arrangement: The cleaning nozzle 26 having the supply mouth 25 is positioned at the forward of a contact portion Wc between the clamp portion 21 and the wafer W in the rotational direction of the roller 20 indicated by arrow in FIG. 4A. Further, the suction nozzle 24 having the suction mouth 23 is positioned at the forward of the cleaning nozzle 26 in the rotational direction of the roller 20.

When the wafer W is rotated, the processing liquid on the peripheral portion of the wafer W is moved to the clamp portion 21 of the roller 20 via the contact portion Wc. The cleaning liquid is supplied from the supply mouth 25 of the cleaning nozzle 26 to the clamp portion 21, thereby cleaning the clamp portion 21 to which the processing liquid has adhered. As the roller 20 is rotated, the cleaning liquid on the clamp portion 21 reaches in front of the suction mouth 23 of the suction nozzle 24, and is then sucked through the suction mouth 23. This arrangement can prevent the cleaning liquid and the processing liquid from being scattered from the wafer W and the clamp portion 21.

FIG. 4C is a cross-sectional view of a modification example of the substrate holder shown in FIG. 4B. As shown in FIG. 4C, a suction passage 27, which has one or more open ends being open at the clamp portion 21, maybe provided inside the roller 20 so that the processing liquid is sucked through the suction passage 27. If the cleaning process is not required, the cleaning nozzle 26 may be eliminated. The suction mouth 23 of the suction nozzle 24 and the suction passage 27 communicate with the vacuum source 13 through the gas-liquid separator 14 (see FIG. 3), so that the liquid is sucked by the vacuum source 13. The processing liquid which has been sucked through the suction nozzle 24 and the suction passage 27 is temporarily collected in the gas-liquid separator 14 where the processing liquid and the gas are separated from each other. The processing liquid recovered by the gas-liquid separator 14 is returned to the first processing liquid supply source 11 and/or the second processing liquid supply source 12 again by the liquid-delivery pump 15 (see FIG. 3), whereby the processing liquid can be reused. In a case where the recovered processing liquid is contaminated, this processing liquid cannot be reused as it is. In such a case, the processing liquid is introduced to the purification device 17 (see FIG. 3) so that the purification device 17 purifies the processing liquid by removing impurities from the processing liquid. The purified processing liquid is then returned to the first processing liquid supply source 11 and/or the second processing liquid supply source 12 for reuse. In a case where the processing liquid is contaminated to such a degree that it cannot be reused even if the purification process is performed, the processing liquid recovered by the gas-liquid separator 14 is discharged through the discharge pipe 18 (see FIG. 3). An ejector or a vacuum pump maybe used as the vacuum source 13. The suction nozzle 24 and the suction passage 27 may be used together with the processing liquid suction unit 3 shown in FIG. 1A, or may be used in substitution for the processing liquid suction unit 3.

As described above, the processing liquid coating apparatus of this embodiment can use the substrate holder of both the vacuum chuck type and the roller type. In a case of using the roller-type substrate holder, another processing liquid supply unit may be provided beneath the wafer.

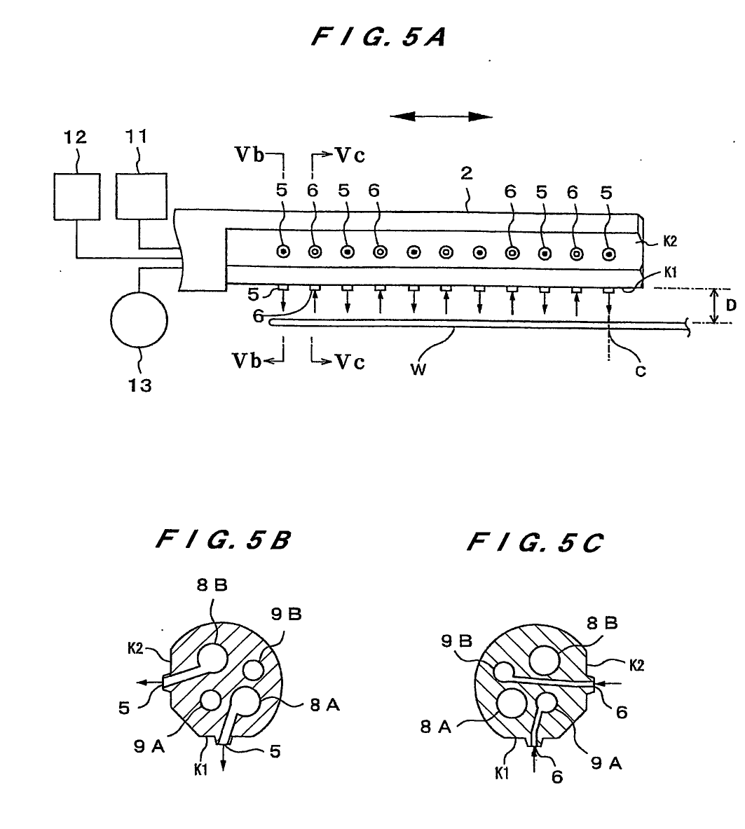

Next, a second embodiment of the present invention will be described with reference to FIGS. 5A through 5C.

FIG. 5A is an enlarged view showing a processing liquid supply unit incorporated in a processing liquid coating apparatus according to a second embodiment of the present invention, FIG. 5B is a cross-sectional view taken along line Vb-Vb of FIG. 5A, and FIG. 5C is a cross-sectional view taken along line Vc-Vc of FIG. 5A. Components and operations of the processing liquid coating apparatus of this embodiment, which will not be described below, are the same as those of the first embodiment.

The processing liquid supply unit 2 of the second embodiment has basically the same structure as the first embodiment. However, the second embodiment is different from the first embodiment in that the second communication passages 9A and 9B are connected to the vacuum source 13 through the gas-liquid separator 14 (see FIG. 3). Therefore, the second supply ports 6 communicating with the second communication passages 9A and 9B serve as suction ports for sucking the processing liquid on the wafer W. Hereinafter, in this embodiment, the second supply ports 6 will be referred to as suction ports 6.

As with the first embodiment, the first communication passage 8A is connected to the first processing liquid supply source 11 and the first communication passage 8B is connected to the second processing liquid supply source 12. The processing liquid is supplied onto the upper surface of the wafer W from the first processing liquid supply source 11 or the second processing liquid supply source 12 through the first supply ports 5. At the same time, the processing liquid which has been supplied onto the wafer W is sucked through the suction ports 6 and the processing liquid suction unit 3 (see FIGS. 1A and 1B).

As an example of this embodiment, the developer may be stored in the first processing liquid supply source 11 and the rinsing liquid may be stored in the second processing liquid supply source 12. In this case, the developer is supplied from the first supply ports 5 provided on the operation surface K1 onto the wafer W, and the developer on the wafer W is sucked through the suction ports 6. Thereafter, the processing liquid supply unit 2 is rotated about its own axis so that the operation surface K2 faces the wafer W. Then, the rinsing liquid is supplied from the first supply ports 5 provided on the operation surface K2 onto the wafer W to stop the development. The rinsing liquid on the wafer W is sucked through the suction ports 6. In this manner, since the supply and the suction of the rinsing liquid is simultaneously performed on the wafer W, the rinsing liquid is quickly replaced with a new rinsing liquid, whereby the development can be stopped accurately at a desired timing.

In this embodiment, the processing liquid such as the resist liquid, the developer, or the rinsing liquid that has been supplied to the wafer W is sucked through the suction ports 6 and the processing liquid suction unit 3 without contacting with any of other components. Therefore, the processing liquid recovered through the suction ports 6 and the processing liquid suction unit 3 can be introduced into the first processing liquid supply source 11 and/or the second processing liquid supply source 12 for reuse. Further, according to this embodiment, because the processing liquid on the wafer W is sucked through the suction ports 6 and the processing liquid suction unit 3, an amount of the processing liquid being scattered from the wafer W can be reduced to substantially zero.

In order to prevent the processing liquid supplied from the first supply ports 5 from being sucked through the suction ports 6 directly, the first supply ports 5 and the suction ports 6 should preferably be spaced from each other by a certain distance. In addition, a certain vertical interval should preferably be provided between the first supply ports 5 and the suction ports 6. In this case, the distance and the vertical interval should preferably be at least 1 mm.

In this embodiment also, the processing liquid which has been sucked through the suction ports 6 and the processing liquid suction unit 3 is temporarily collected in the gas-liquid separator 14 (see FIG. 3) where the processing liquid and the gas are separated from each other. The processing liquid recovered by the gas-liquid separator 14 is returned to the first processing liquid supply source 11 and/or the second processing liquid supply source 12 again by the liquid-delivery pump 15 (see FIG. 3), whereby the processing liquid can be reused. In a case where the recovered processing liquid is contaminated, this processing liquid cannot be reused as it is. In such a case, the processing liquid is introduced to the purification device 17 (see FIG. 3) so that the purification device 17 purifies the processing liquid by removing impurities from the processing liquid. The purified processing liquid is then returned to the first processing liquid supply source 11 and/or the second processing liquid supply source 12 for reuse. In a case where the processing liquid is contaminated to such a degree that it cannot be reused even if the purification process is performed, the processing liquid recovered by the gas-liquid separator 14 is discharged through the discharge pipe 18 (see FIG. 3).

The supply-suction structure of this embodiment can recover almost all the processing liquid without allowing the processing liquid to be scattered from the wafer W. Therefore, this embodiment is advantageous in that a larger amount of the processing liquid that can be utilized for reuse compared to the first embodiment.

As described above, the processing liquid coating apparatus is suitable for use as a resist coating apparatus for coating a resist film on a surface of a substrate and a developing apparatus for supplying a developer onto the resist film, to which circuit patterns are transferred, to form circuit pattern grooves.

### INDUSTRIAL APPLICABILITY

The present invention is applicable to a processing liquid coating apparatus and a processing liquid coating method suitable for use in a lithography process for forming fine circuit patterns on a surface of a substrate such as a semiconductor wafer.

1. A processing liquid coating apparatus for coating a surface of a substrate with a processing liquid, said apparatus comprising:
a substrate holder for holing and rotating the substrate; and
a processing liquid supply unit disposed apart from the substrate held by said substrate holder;
wherein said processing liquid supply unit has a plurality of supply ports for supplying the processing liquid to a plurality of portions including a central portion of the surface of the substrate, and the processing liquid is a resist liquid or a developer.

2. A processing liquid coating apparatus according to claim 1, wherein said processing liquid supply unit has a plurality of suction ports for sucking the processing liquid on the substrate.

3. A processing liquid coating apparatus according to claim 2, wherein said plurality of supply ports and said plurality of suction ports are arranged alternately and linearly.

4. A processing liquid coating apparatus according to claim 1, wherein said processing liquid supply unit is movable in a radial direction of the substrate.

5. A processing liquid coating apparatus according to claim 1, further comprising a processing liquid suction unit for sucking the processing liquid from a peripheral portion of the substrate.

6. A processing liquid coating apparatus according to claim 2, further comprising a gas supply unit for ejecting a gas toward the surface of the substrate, said gas supply unit being movable from the central portion to a peripheral portion of the substrate.

7. A processing liquid coating method for coating a surface of a substrate with a processing liquid, said method comprising:
rotating the substrate; and
supplying the processing liquid to a plurality of portions including a central portion of the surface of the substrate;
wherein the processing liquid is a resist liquid or a developer.

8. A processing liquid coating method according to claim 7, further comprising sucking the processing liquid from a plurality of portions of the surface of the substrate.

9. A processing liquid coating method according to claim 7, further comprising sucking the processing liquid from a plurality of portions including a peripheral portion of the surface of the substrate.

10. A processing liquid coating method according to claim 7, further comprising:
ejecting a gas from a gas supply unit toward the surface of the substrate; and
moving said gas supply unit from the central portion to a peripheral portion of the substrate.

11. A processing liquid coating apparatus according to claim 2, further comprising a processing liquid suction unit for sucking the processing liquid from a peripheral portion of the substrate.

12. A processing liquid coating apparatus according to claim 3, further comprising a processing liquid suction unit for sucking the processing liquid from a peripheral portion of the substrate.

13. A processing liquid coating apparatus according to claim 4, further comprising a processing liquid suction unit for sucking the processing liquid from a peripheral portion of the substrate.

14. A processing liquid coating apparatus according to claim 2, further comprising a gas supply unit for ejecting a gas toward the surface of the substrate, said gas supply unit being movable from the central portion to a peripheral portion of the substrate.

15. A processing liquid coating apparatus according to claim 3, further comprising a gas supply unit for ejecting a gas toward the surface of the substrate, said gas supply unit being movable from the central portion to a peripheral portion of the substrate.

16. A processing liquid coating apparatus according to claim 4, further comprising a gas supply unit for ejecting a gas toward the surface of the substrate, said gas supply unit being movable from the central portion to a peripheral portion of the substrate.

17. A processing liquid coating apparatus according to claim 5, further comprising a gas supply unit for ejecting a gas toward the surface of the substrate, said gas supply unit being movable from the central portion to a peripheral portion of the substrate.

18. A processing liquid coating method according to claim 8, further comprising:
ejecting a gas from a gas supply unit toward the surface of the substrate; and
moving said gas supply unit from the central portion to a peripheral portion of the substrate.

19. A processing liquid coating method according to claim 9, further comprising:
ejecting a gas from a gas supply unit toward the surface of the substrate; and
moving said gas supply unit from the central portion to a peripheral portion of the substrate.
